(19) United States
(12) Patent Application Publication
(10) Pub. No.: US 2018/0333908 A1
(43) Pub. Date: Nov. 22, 2018

(54) Machine for Detection of Filament Feed Error in 3D Printers

(71) Applicant: Edward Earl Lewis, Little Rock, AR (US)

(72) Inventor: Edward Earl Lewis, Little Rock, AR (US)

(21) Appl. No.: 15/599,801

(22) Filed: May 19, 2017

(51) Int. Cl. B29C 47/92; B29C 64/321

(52) U.S. Cl. CPC B29C 47/92; B29C 64/321; B29C 64/106; B29C 2947/92761; B29C 2947/92295

(57) ABSTRACT

A Machine for Detection of Filament Feed Error in 3D Printers by draft of filament to determine if error of filament feed is occurring. The digital output can be connected to the pause input of the computer or controller. Examples of such a machine is adding a low cost solution to pause a 3d printer when a filament feed error has occurred such as by the termination of the filament or the filament seizing and save the item in process.

### BACKGROUND OF THE INVENTION

### Field of the Invention

The present invention relates to a method of detecting errors feeding filament in additive manufacturing of three-dimensional shaped objects.

### Description of the Background

In additive manufacturing of three-dimensional-shaped-objects or 3D printing one of the problems is the filament will seize or terminate unexpectedly while the 3D printer continues the printing process without material. This produces a partially manufactured object that is a waste of material and time. Seizing can be caused by a plurality of causes not limited to the filament becoming entangled or jamming. By detecting filament feed errors the 3D printer can be paused while somebody corrects the error, then resume printing saving the object.

### SUMMARY OF THE INVENTION

The object of the current invention is to provide a method to pause the 3D printer when a filament feed error occurs. The operator can then repair the error and resume printing the object. 3D printers are usually equipped with an input to pause printing. 3D printing uses raw material called filament that is object made of different materials dependent on the application that is formed to elongated object of constant diameter.

### BRIEF DESCRIPTION OF THE DRAWINGS

FIG. 1 shows the circuit schematic to detect the filament error and emit output.

FIG. 2 shows the logic implemented by the circuit.

FIG. 3 shows a diagram with embedded said circuit with physical parts to detect filament error.

### DETAILED DESCRIPTION

One embodyment of detecting filament feed errors is by comparing the filament longitudinal movement to motor turning. A counter is used keep up with the difference. The counter is incremented by movement on the motor driven feed spindle feeding the filament and is reset to zero by the movement of the friction driven monitor spindle. Both said spindles movement is detected by encoders. As long as the counter is reset by movement of the monitor spindle no error exists otherwise error is detected. The friction of the filament to is the only force turning the monitor spindle. By detecting only change in signals from encoders the method is time or speed independent. The amount of drift allowed between the spindles is set to a preselected value, which may be known as sensitively.

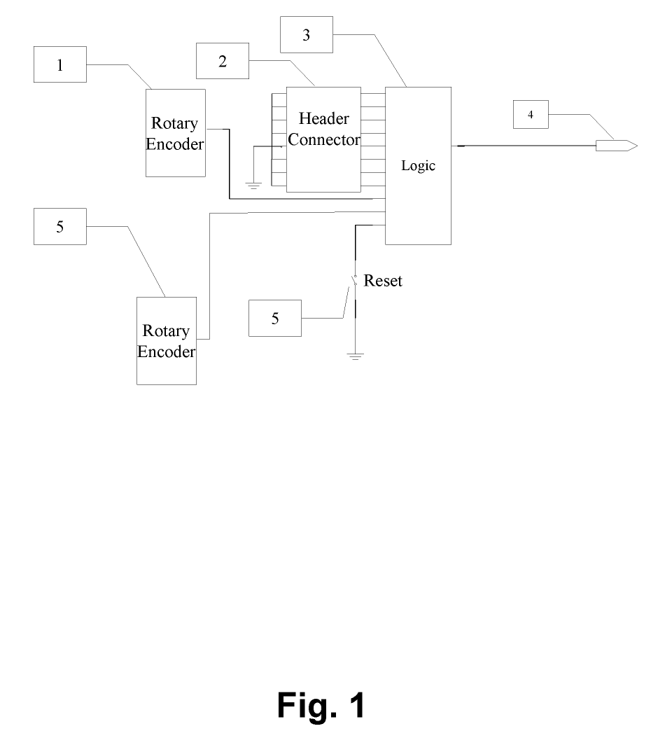

FIG. 1 is a schematic diagram of the electronic circuit that detects filament feed errors.

The circuit consists of:

Two rotatory encoder inputs, from the 1 feed rotary encoder and 5 monitor rotary encoder.

A 2 header connector used with straps to select the sensitively.

The 3 logic that can be implemented by microprocessor, programmable logic or discrete logic.

4 Error output used to pause the 3D printer.

A 5 reset switch to reset the circuit and 3 counter to zero.

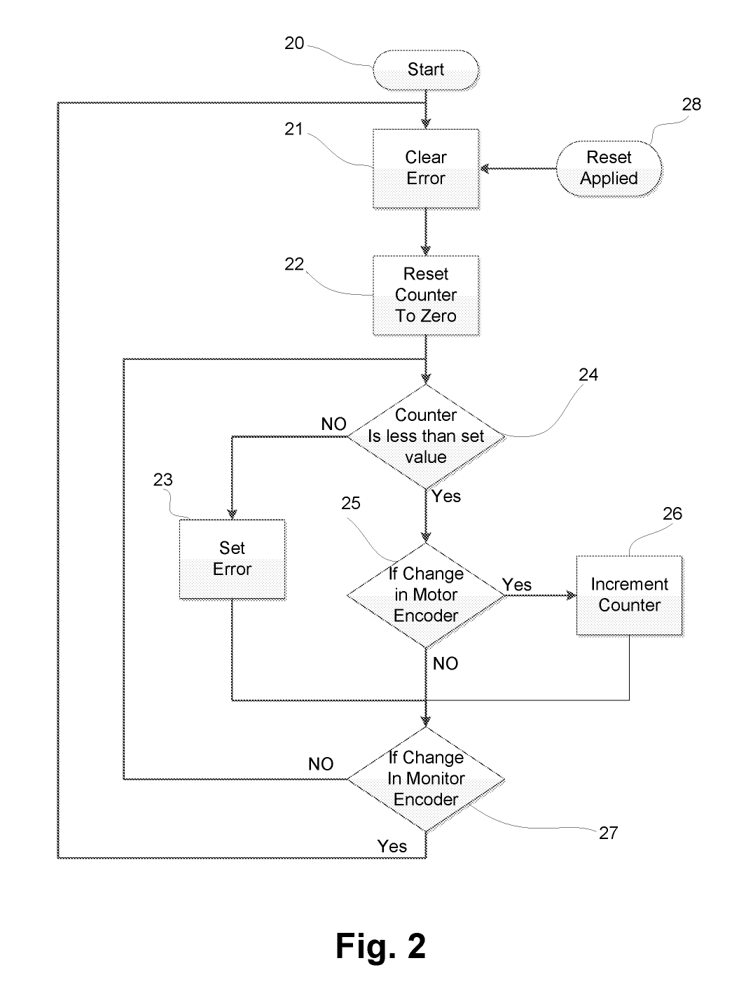

FIG. 2 is a flowchart of the logic implemented in the electronic circuit:

At stage 20 the logic starts then proceeds to stage 21

Stage 21 the clears the error output then proceeds to stage 22.

At stage 22 the counter is set to zero then proceeds to stage 24.

In stage 24 the counter is compared to the preselected value and if less than proceeds to stage 25 else to stage 23.

Stage 25 checks for a change in the motor encoder input signal, if a change than proceed to stage 26 else to stage 27.

At Stage 23 the error output is set then proceeds to stage 27.

At stage 26 the counter is incremented by one then proceeds to stage 27.

Stage 27 checks for a change friction encoder input signal, if a change than proceed to stage 21 else to stage 24.

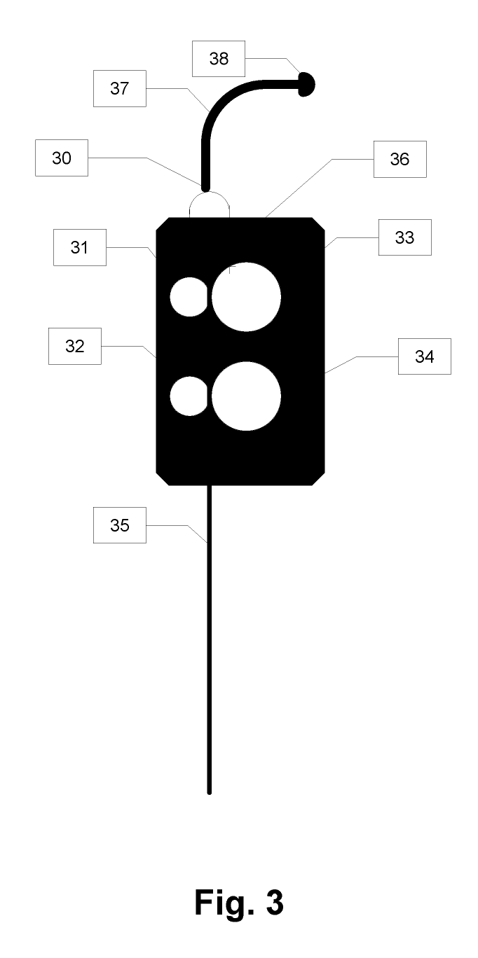

FIG. 3 shows the physical layout:

Case 36 contains the encoders, spindles, capture block and pinch rollers.

The 35 filament is feed between 32 friction spindle and 34 pinch roller that is spring loaded to apply pressure to hold the 35 filament to the 33 friction spindle.

Then between 31 feed spindle and 33 pinch roller that is spring loaded to apply pressure to hold the 35 filament to the 32 feed spindle.

31 speed spindle extrudes the 35 filament into 30 feed block then down 37 tube finally 38 die (also known as hot end).

When a feed error occurs the 22 monitor spindle stops due to no draft of filament.

The 21 feed spindle continues turning being driven by a motor.

When the 22 monitor spindle stops and the 21 feed spindle continues to turn the detector counts up to a predetermined count and emits an error.

I clam:

1. A Machine for Detection of Filament Feed Error in 3D Printers by detecting a lack of movement of the filament during extrusion caused by the termination of the filament or the filament seizing from a polarity of causes, comprising:
a monitor device that turns the lateral movement of the filament into logical signals,
a feed device driven by a motor to force the filament laterally to die or tube that leads to die that,
said fee device produces logical signals when said feed device is motion that,
said fee device has enough force to continue moving but not enough traction to move said filament when said feed error exists,
a controller that exams the signals from said monitor and said feed device that,
said controller increments a counter on change of the feed signal,
said controller resets said counter to zero on change of the monitor signal,
said controller determines if said counter is exceed by a predetermined amount thereby,
said controller will emit an error logical signal, and
resetting said controller will clear said error logical signal, and
said controller is time independent since operating on change only,
whereby Said error logic signal can be provided to the 3D printer controller to pause said 3D printer thereby permitting an operator to correct the error then resume printing, reducing waste.

2. A Machine for Detection of Filament Feed Error in 3D Printers of claim 1 will substitute for use as an extruder in 3D Printers.
